(19) United States
(12) Patent Application Publication
(10) Pub. No.: US 2025/0354664 A1
(43) Pub. Date: Nov. 20, 2025

(54) LIGHT FIXTURE CONFIGURED FOR SKY EMULATION

(71) Applicant: ABL IP Holding LLC, Atlanta, GA (US)

(72) Inventors: Zachary Ingalls, Littleton, CO (US); Carl Gould, Golden, CO (US); Chris Sorensen, Arvada, CO (US)

(73) Assignee: ABL IP Holding LLC, Atlanta, GA (US)

(21) Appl. No.: 18/663,744

(22) Filed: May 14, 2024

(51) Int. Cl. F21K 9/64; F21K 9/66; F21V 9/02; F21Y 105/16; F21Y 115/10

(52) U.S. Cl. CPC F21K 9/64; F21K 9/66; F21V 9/02; F21Y 2105/16; F21Y 2115/10

(57) ABSTRACT

A light fixture for emulating sky appearance is described. The light fixture can include a plurality of light sources, a diffuser spaced a distance from the light sources, and one or more optics positioned proximate and over at least some of the plurality of light sources such that at least one light source emits light into each of the one or more optics. The one or more optics can include a subset of colored optics. The plurality of light sources when activated project, via the one or more optics, a predetermined image on the diffuser.

### FIELD OF DISCLOSURE

The present disclosure relates to a light fixture and methods of controlling the light fixture to generate static and/or dynamic images on the light fixture.

### BACKGROUND

Light fixtures exist that emulate skylights by creating illusions of the sky. Such light fixtures eliminate the need for roof exposure but rather can be installed in enclosed spaces such as medical rooms, offices, building lobby, etc. Typically, the sky images are created using a colored graphic inlay or panel bearing an image of the sky. For example, the panel can include a film printed with a sky image that is provided on a light receiving side of the panel. The panel can be deployed as a diffuser panel within a lighting system or as a separate panel attached to the diffuser that can be replaced upon degradation. Regardless, the sky image is illuminated when light from the fixture passes through the panel.

However, provision of a colored film on the panel reduces the lumen output of the fixture and renders the fixture incapable of operating in an all-white light mode. The graphic inlay typically includes light absorbing and diffusing materials. As such, existing sky emulating fixtures have low optical efficiency due to diffusing and absorbing materials e.g., even in white cloud sections. Moreover, the colored graphic inlay is visible even when the light sources of the light fixture are not activated or in an off state.

### BRIEF SUMMARY

One aspect of the present disclosure relates to lighting systems. For example, the lighting fixture can include a plurality of light sources, a diffuser spaced a distance from the light sources, and one or more optics positioned proximate and over at least some of the plurality of light sources such that at least one light source emits light into each of the one or more optics. The one or more optics includes at least a subset of colored optics. The plurality of light sources project, via the one or more optics, a predetermined image on the diffuser.

In another aspect, a lighting system for lighting an area is described. The lighting system can include a light fixture a trim defining an aperture; a first plurality of light sources; and a second plurality of light sources. The lighting system is configured to light the area in a first mode or a second mode through the aperture. In the first mode, the second plurality of light sources is inactive and the first plurality of light sources is active to light the area through the aperture. In the second mode, the first plurality of light sources is inactive and the second plurality of light sources is active and projects a predetermined image through the aperture.

In another aspect, a light fixture includes first set of LEDs, a second set of LEDs, and a diffuser. The first set of LEDs is spaced from each other, each LED of the first set of LEDs emitting light of a first color. The first set of LEDs being spaced from each other to form an irregular layout within the light fixture. Within the irregular layout, the first set of LEDs are staggered between rows or spaced to have different distances among the first set of LEDs. The second set of LEDs is spaced from each other to form an irregular layout within the light fixture. Within this irregular layout, the second set of LEDs are staggered between rows or spaced to have different distances among the second set of LEDs. Each LED of the second set of LEDs emitting light of a second color different from the first color. The diffuser spaced from the first and second set of LEDs, the diffuser comprising a light entry side and a light exit side. Light emitted by the first set of LEDs and the second set of LEDs is projected on the light entry side of the diffuser to create a predetermined image visible from the light exit side of the diffuser.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values or dimensions illustrated in the accompanying graphs and figures are for illustration purposes only and can or cannot represent actual or preferred values or dimensions. Where applicable, some or all features cannot be illustrated to assist in the description of underlying features. The patent or application file contains at least one drawing executed in color. Copies of this patent or patent application publication with color drawing(s) will be provided by the Office upon request and payment of the necessary fee. In the drawings:

FIG. 1A is an exploded view of a light fixture, according to various embodiments;

FIG. 1B is a cross-sectional view of the light fixture of FIG. 1A;

FIG. 2 is an example optics formed as an overlay, according to various embodiments;

FIG. 3 is an example configuration of light sources and optics to project a predetermined image on a diffuser of the optical assembly of FIG. 1A;

FIG. 4 illustrates examples of dome shaped colored optics and a clear optic, according to various embodiments;

FIG. 5A illustrates a non-image mode of operation of the optical assembly of FIG. 1A;

FIG. 5B illustrates an image mode of operation of the optical assembly of FIG. 1A;

FIG. 6 illustrates an example subassembly of optics including discrete colored domes coupled with light sources, according to some embodiments;

FIG. 7 illustrates the subassembly of FIG. 6 with the light sources activated;

FIG. 8 illustrates an example of a predetermined image projected on a diffuser by the subassembly of FIG. 7;

FIG. 9 illustrates an example of a primary backlight lens including integrally formed colored optics, according to some embodiments;

FIG. 10A illustrates the backlight lens of FIG. 9 with the light sources in activated;

FIG. 10B illustrates an example of a predetermined image projected on a diffuser by the backlight lens of FIG. 10A;

FIG. 11A illustrates an optical subassembly including a first configuration of light sources to generate a predetermined image without colored optics, according to some embodiments;

FIG. 11B illustrates an example of the predetermined image projected on a diffuser by the optical subassembly of FIG. 11A;

FIG. 11C illustrates an optical subassembly including the first configuration of light sources shown in FIG. 11A but with each light source covered with a clear backlight lens to generate a predetermined image without colored optics, according to some embodiments;

FIG. 11D illustrates an example of the predetermined image projected on a diffuser by the optical subassembly of FIG. 11C;

FIG. 12A illustrates an optical subassembly including a second configuration of light sources to generate variations of a predetermined image without colored optics, according to some embodiments;

FIG. 12B illustrates an example of a cool sky projected on a diffuser by the optical subassembly of FIG. 12A;

FIG. 12C illustrates an example of a warm sky projected on a diffuser by the optical subassembly of FIG. 12A;

FIG. 13 is a flow chart of a method for lighting a diffuser, according to various embodiments; and

FIG. 14 is a block diagram of a light assembly, according to various embodiments.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed embodiment(s). However, it will be apparent to those skilled in the art that the disclosed embodiment(s) can be practiced without those specific details. In some instances, well-known structures and components can be shown in block diagram form in order to avoid obscuring the concepts of the disclosed subject matter.

The present disclosure provides one or more optics including a subset of colored optics. The one or more optics can be separate components positioned proximate to a light source. In an embodiment, the one or more optics can be part of a first optic (e.g., a backlight lens optic, or a “button optic”) configured to include colored portions. The one or more optics including the colored optics can be configured to generate a predetermined image. The one or more optics can include non-diffusing material, which also results in efficiency gains for a light fixture. Unlike existing sky images, the predetermined image herein is not positioned on or close to a diffuser. Instead, the one or more optics are positioned close to light sources that project the predetermined image onto the diffuser. As a result, different optical systems with different predetermined images can be manufactured and switched out to change the appearance of the same light fixture.

In many embodiments, the one or more optics can include three-dimensional (3D) domes. The domes can include a combination of colored domes and clear domes configured to project a colored image onto the diffuser. For example, blue colored sky can be created by blue colored domes, and clouds can be created from clear domes. Hence, the clear domes or clear portions of the optics result in efficiency gains. Furthermore, the optics configuration herein enables at least two modes of operation-a non-image mode and an image mode—from the same aperture. Optical fixtures of the present disclosure show none or very subtle coloration when the light sources are in an off-state. In contrast, colored image inlays serving as diffusers or placed on the diffuser typically use white pigment for clouds, which causes efficiency loss as light is absorbed by the white pigment. Furthermore, the colored image inlay (e.g., sky appearance) is always visible even if the light sources are in an off-state. Existing light fixtures cannot operate in two different modes (e.g., an image mode and a non-image mode) from the same aperture as the colored image inlay on the diffuser and light always exists through the colored image inlay.

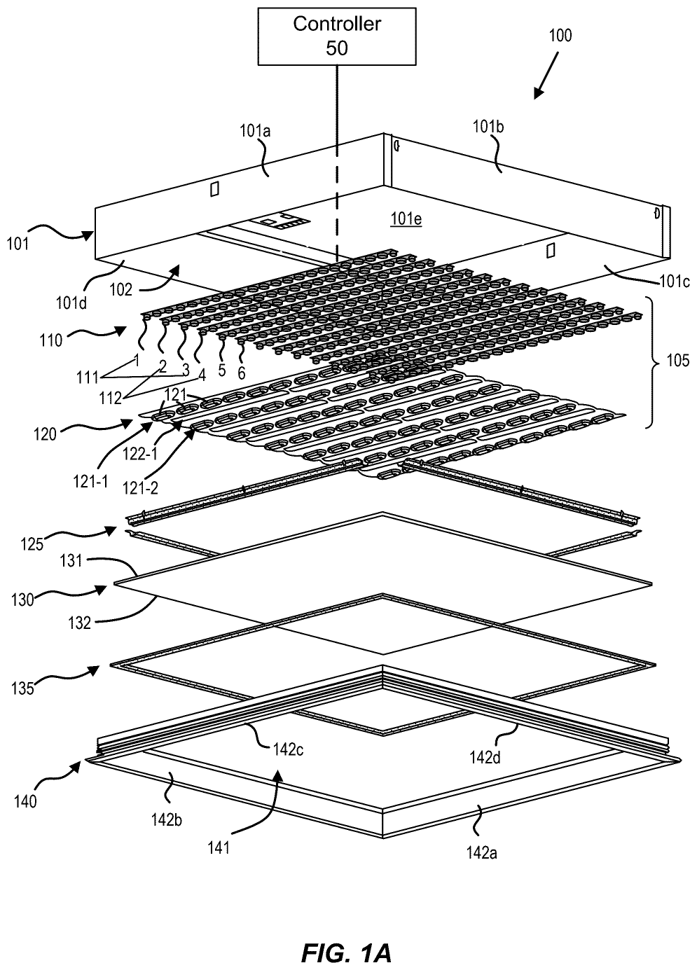

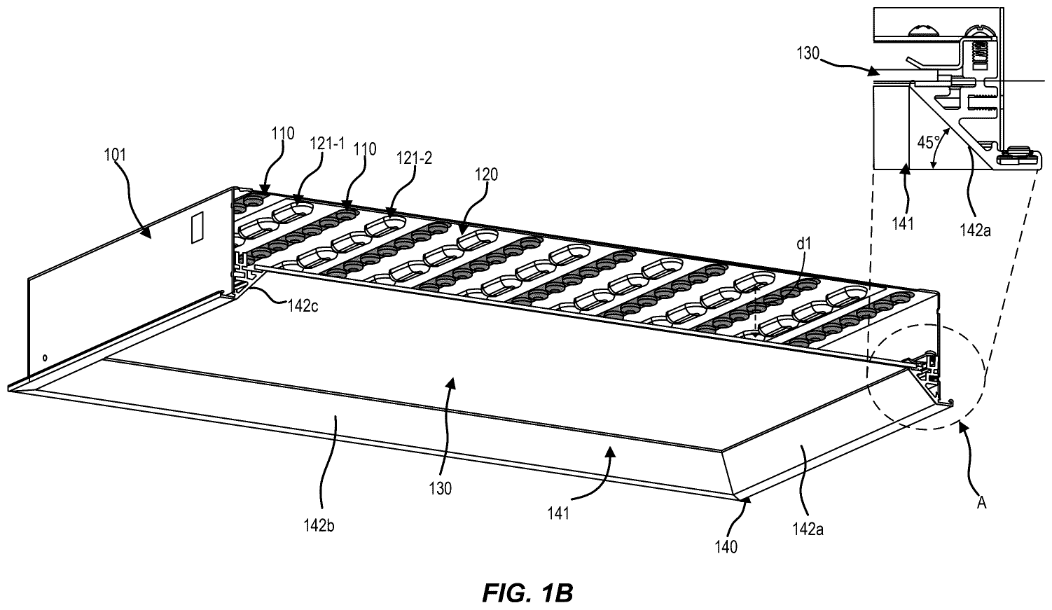

FIGS. 1A and 1B illustrate an embodiment of a light fixture 100 in an exploded and assembled state, respectively. In some embodiments, the light fixture 100 includes a housing 101, an image projection optical subassembly 105, one or more retaining brackets 125, a diffuser 130, a gasket 135 and a beveled trim 140.

The housing 101 can be configured to receive different components of the light fixture 100. The housing 101 can have a substantially rectangular box like shape having sidewalls 101a-101d, a top wall 101e and a housing opening 102. The image projection optical subassembly 105 and the diffuser 130 can be positioned within the housing 101. The beveled trim 140 can be coupled to the opening 102 of the housing 101. In the illustrated embodiment, the retaining bracket 125 affixes the diffuser 130 to the beveled trim 140. The beveled trim 140 can be used to retain the diffuser 130 within the housing 101 at a specified distance (e.g., d1) from the optical subassembly 105. The gasket 125 can seal the housing opening 102, thereby preventing ingress of moisture, dust, and other contaminants detrimental to the light fixture 100.

The diffuser 130 can diffuse output of the light projected from the image projection optical subassembly 105. For example, the diffuser 130 can reduce brightness to soften the light. The light receiving side 131 of the diffuser 130 can be smooth or textured. The light emitting side 132 may be smooth or textured. The diffuser 130 can extend below the optical subassembly 105 and over the entire opening 102 of the housing 101. The diffuser 130 can be substantially planar, include a curved surface, or other geometrical surfaces to generate a specified lighting effect or distribution. In some embodiments, the diffuser 130 may include facets.

The beveled trim 140 can include a viewing aperture 141 through which the predetermined image on the diffuser 130 can be viewed. The beveled trim 140 and the aperture 141 can be configured to mimic an opening in a window or skylight providing an outside view (e.g., of a sky). For example, the beveled trim 140 can include inclined beveled edges 142a-142d. In some embodiments, as shown in FIG. 1B, the height of the beveled edges 142a-142d can be modified to improve aesthetics of the light fixture and/or achieve the specified distance d1 between the diffuser 130 and the image projection optical subassembly 105. In some embodiments, a specified distance d1 can be achieved by adjusting the depth of the housing 101. For example, a depth of the housing can be pre-determined to distance d1. In another example, the beveled trim 140 can be configured such that when the diffuser 130 is coupled to the trim 140, the distance d1 between the diffuser 130 and the image projection optical subassembly 105 can be maintained. In some embodiments, the beveled edges 142a-142d can extend inward into the housing 101 so that the diffuser 130 is recessed within the housing 101. In other embodiments, the diffuser is not recessed but rather extends coplanar with the bottom of the trim 140.

In some embodiments, the image projection optical subassembly 105 can include a plurality of light sources 110 and an optic 120 configured to collectively create a predetermined image. As best seen in FIG. 1B, when assembled, the image projection optical subassembly 105 and the diffuser 130 are retained a vertical distance (d1) from each other within the housing such that a space exists between the components. In one mode of operation, the image projection optical subassembly 105 is configured to project a predetermined image (e.g., a colored sky) onto the diffuser 130. More specifically, the light sources 110 emit light into the optic 120, which, in turn, projects color onto the diffuser 130 to create an image.

The light sources 110 may be provided within the light fixture 100 in any number and in any configuration. In some embodiments, the light sources 110 are arranged in an layout, for example, a plurality of light rows and/or columns. The light sources 110 can be in a plane (e.g., a parallel plane) offset from a plane of the diffuser 130. The light sources 110 can be light emitting diodes (LEDs) or other light sources. The light sources 110 can be characterized by light parameters, such as wavelength, intensity, polarization, color, correlated color temperature (CCT), x,y values of International Commission on Illumination (CIE) color space, or other parameters. The light sources 110 can be mounted on one or more printed circuit boards (“PCBs”). In some embodiments no PCB is needed; rather, the light sources 110 are chip-on-board LEDs provided directly on the underside of the housing 101.

In some embodiments, the light sources 110 can be on a single channel such that all of the light sources 110 are controlled uniformly (i.e., if one light source is on, they all are on and vice versa). In other embodiments, the light sources 110 are divided into multiple channels that can be controlled independently to create different lighting modes. A light channel can be one or more light sources electrically connected together so that all the light sources can be controlled simultaneously. One or more channels of the light sources 110 can be activated or deactivated or dimmed to control an intensity, a color variation, or other light parameter of the light emitted from the light sources 110.

In many embodiments, the light sources 110 can be controlled via a light controller 50 configured to control lighting modes of the light fixture 100. For example, the light controller 50 can control one or more lighting parameters, activate and/or deactivate or dim the light sources 110. In some embodiments, the light controller 50 can be a switch that is electrically wired to the light sources 110. In some embodiments, the light controller 50 can be a programmable electronic controller (not illustrated for simplicity) installed in the housing 101. In some embodiments, the light controller 50 can be a wireless controller communicating with the electronic controller in the housing 101 and configured to wirelessly control the lighting modes of the light fixture 100.

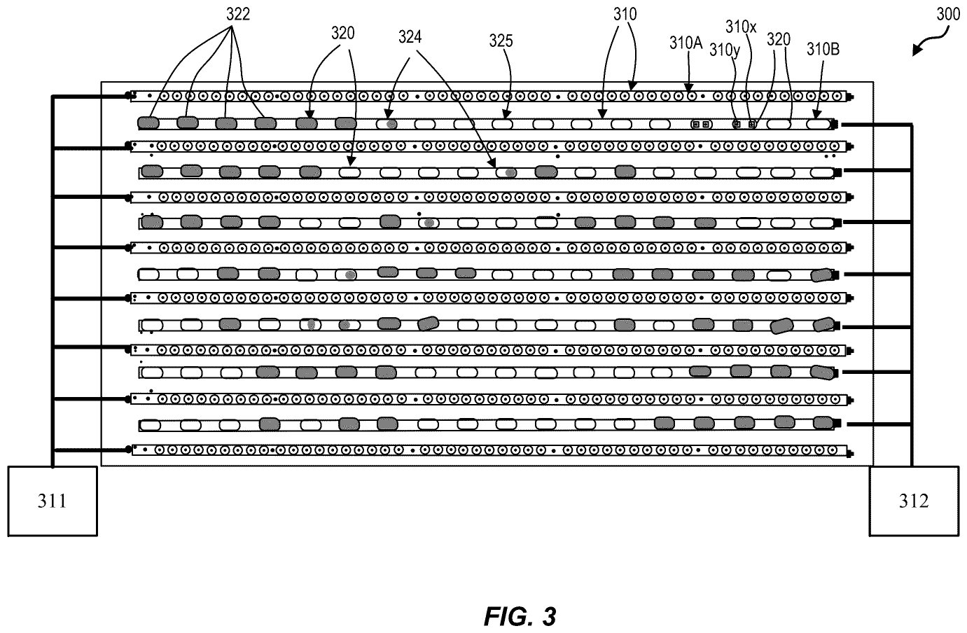

In some embodiments, the light sources 110 are identical in that they have identical lighting parameters. In other embodiments, the light sources 110 can include two or more sets of light sources having different light characteristics. For example, the light sources 110 can be divided into a first channel 111 (e.g., odd numbered rows 1, 3, . . . , in FIG. 1A) and a second channel 112 (e.g., even numbered rows 2, 4, . . . , in FIG. 1A) that can be controlled independent of the first channel 111. The first channel 111 and the second channel 112 may have different lighting characteristics according to specified light parameter values. Each channel can be configured to generate a specified lighting effect. The first channel 111 can include a first set of light sources having a specified characteristic such as a first correlated color temperature (CCT) (e.g., 2700K or less), a specified intensity value, or other single or a combination of light parameter values. The second channel 112 can include a second set of light sources having another characteristics such as a second CCT (e.g., 5000K or more), another specified intensity value, or other single or a combination of light parameter values. In some embodiments, the plurality of light sources 110 can further include a third channel (not illustrated) comprising a third set of light sources having yet another characteristic such as a third CCT (e.g., from 2700K to 5000K). Each of the first channel 111, the second channel 112, and the third channel can be independently controlled. For example, a channel can be controlled via a controller (e.g., a user interface on a digital device) or electrically connected to a manually operated wall switch. For example, FIG. 3 (discussed in detail later) illustrates an optic 120 for use with a light fixture having at least two channels. These two channels enable the light fixture to create an image mode and a non-image mode. In some embodiments, the image mode can be tunable by adjusting light parameters of the second set of light sources in conjunction with the third set of light sources, as will be discussed in further detail below.

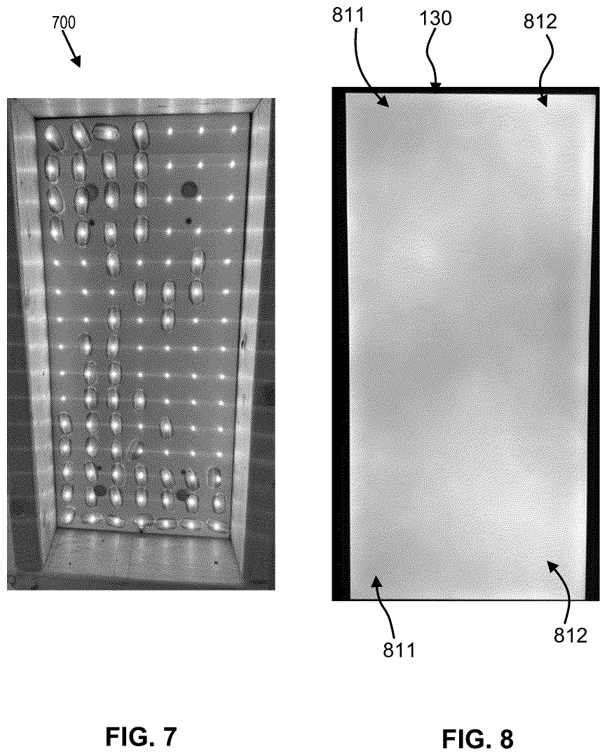

In some embodiments, the light sources 110 can have identical light parameter values (e.g., same color value, same intensity value, CIE values, etc.). For example, each light source of the light sources 110 can be a light emitting diode (LED) characterized by a light parameter such as correlated color temperature (CCT) having a value of 2700K, 3500K, 5000K or other specified values. In this case, the light sources 110 can be considered to be on a single channel or operable in a single mode. For example, FIG. 7 (discussed in detail later) illustrates an example of the light sources with the same light characteristics that are used to create a specified image (e.g., a cool sky or a warm sky).

The image projection optical subassembly 105 further includes one or more optics that receive the light emitted by one or more light sources 110. As described herein, the term “optic” refers to one or more components interacting with light from a light source to generate a specified image or light distribution. The optic may be a first optic (e.g., backlight lens or “button optic”) or a second optic configured to include one or more colored portions. The first optic is a lens positioned directly over an LED to receive light from the LED and uniformly spread over the diffuser. The first optic can serve to protect and shape the output of the LED. In some embodiments, the LED can create a Lambertian distribution. In some embodiments, the first optic creates a wide batwing distribution for uniformly lighting the diffuser. In some embodiments, the first optic can be referred to as a backlight lens as it lights a diffuser from a backside—i.e. from behind the diffuser. The first optic can be coupled (e.g., via adhesive) over the LED or it can be directly attached to the substrate. The first optic can be, for example, a backlight lens, or a button optic. The second optic refers to a component configured to modify the light passed through the first optic to create a desired light distribution or an image (as discussed herein). In the present disclosure, if the optic is a second optic, it may include discrete optical structures that are mounted individually over one or more light sources or may be formed as a sheet in which a plurality of optical structures are provided so as to align with the light sources when the sheet is positioned adjacent the light sources. The optic can be made of non-diffusing material, non-absorbing material, and/or materials that allow light to pass through with minimal refraction or scattering. For example, the optic can be made of a silicone, acrylic, polycarbonate, PET or other moldable optical material.

Regardless of the type of optic, at least some of the optic(s) (or portions thereof) are colored (e.g., such as blue). To create a sky image, for example, at least some light from the light sources 110 passes through the colored optics whereas other of the light does not. In this way, a blue and white sky image is created on the diffuser.

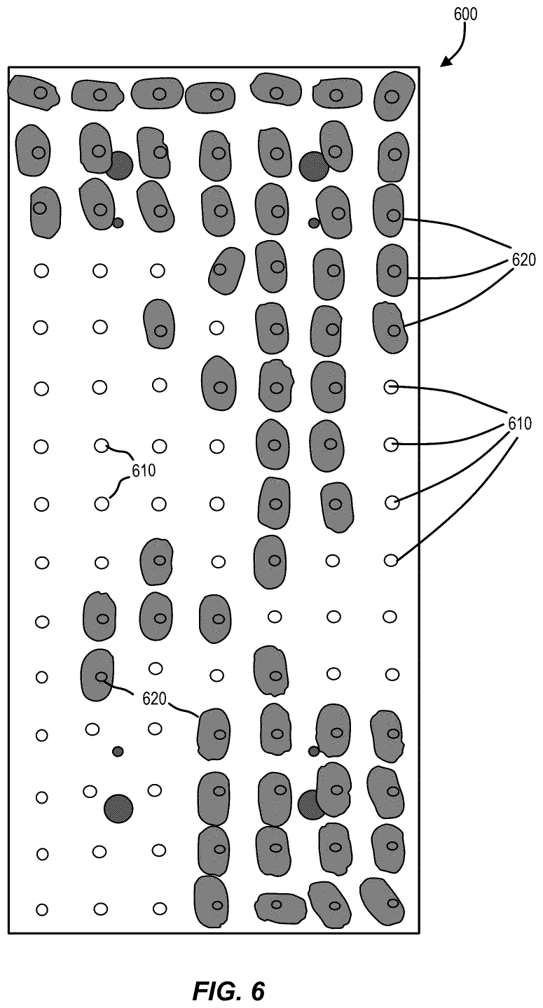

In many embodiments, the optic can be or include a plurality of optics. For example, the optic can be configured as a plurality of optical structures provided or formed integrally on a sheet or a panel (as shown in FIGS. 1-3) that is provided adjacent to the light sources 110 (e.g., attached to the PCB or housing via adhesive, fasteners, or other attachment means). As another example, the optic can be configured as a plurality of discrete optics, as shown in FIG. 6. In many embodiments, the plurality of optics can include colored portions configured to generate a predetermined image (e.g., sky, beach, or other scenes). For example, the plurality of optics can include a subset of colored optics that may be arranged or patterned to create the predetermined image. The optics can bear any color or multiple colors. In many embodiments, the optic (e.g., 120) can include a subset of colored optics, a subset of clear optics, or a combination thereof. The clear optics have negligible to no effect on the light emitted from the light sources. Accordingly, in some examples, the clear optics can be optional and only colored optics are included without affecting the predetermine image. The subset of colored optics and/or clear optics can be arranged relative to each other so as to generate a predetermined image (e.g., sky). When the light sources 110 are activated, light is emitted through the optic (e.g., 120) to project the predetermined image (e.g., a sky, a beach, or other outdoor scenes) on the diffuser (e.g., 130). In this way, the image is created not by the diffuser itself bearing the image (as is the case when a film bearing the pattern is provided on or adjacent the diffuser) but rather by the interaction between the light (emitted from the light sources 110) and the optic which casts the desired image onto the diffuser.

In the illustrated embodiments, shown in FIGS. 1-3, the optic 120 can include dome structures 121. Individual domes are labelled 121a, 121b, 121c, 121d for reference. The domes 121 may be, but do not have to be, arranged in rows (e.g., a first dome row 121-1, a second dome row 121-2, etc.). The domes 121 that may be formed integrally with an optic overlay 200. By way only of example, the domes 121 can be thermoformed or vacuum formed on the optic overlay 200. In some embodiments, the domes 121 may be 3D printed using appropriate material as discussed herein.

The optic overlay 200 can be a base or a sheet to facilitate handling and/or installation of the optic 120 within the light fixture 100. For example, it is simpler to install a single optic overlay 200 bearing the optic structures as opposed to discrete optic structures (as shown in FIG. 3). The overlay 200 may be a clear sheet, or a dark colored sheet e.g., made of silicone, plastic or other optic material. The overlay 200 may be coupled relative to the light sources 110 via fasteners such as screws or adhesive. In some embodiments, the domes 121 of the overlay 200 can include colored domes (e.g., shaded domes 121a-121d) and/or clear domes (e.g., non-shaded domes 121x-121y). In some embodiments, clear domes may be omitted and only colored domes may be provided on the overlay 200. Accordingly, light emitted through the colored domes can create a colored graphic portion (e.g., blue portions) of the predetermined image (e.g., sky), and the light emitted directly from the LED (or a backlight lens thereon) can form a non-colored portion (e.g., white clouds).

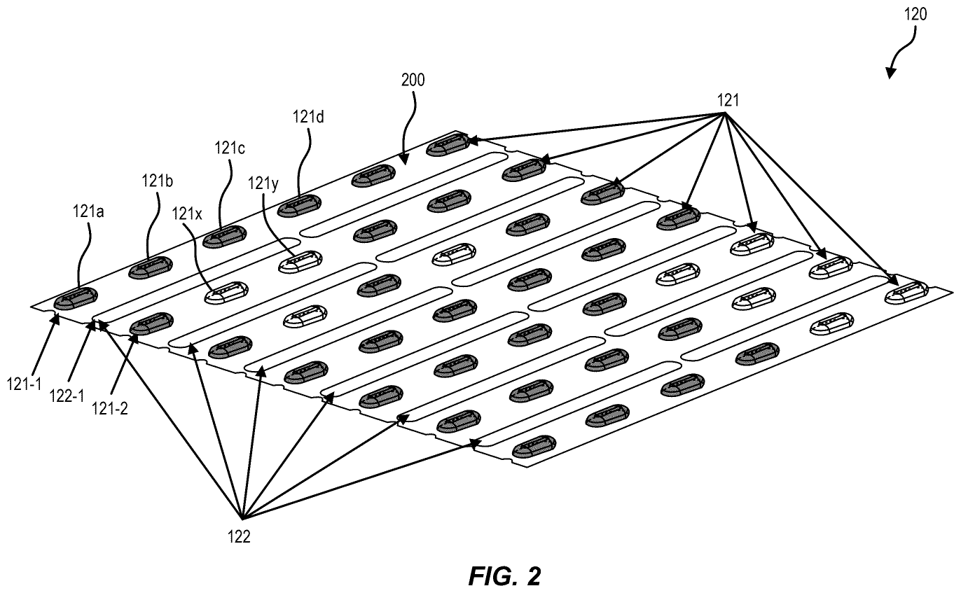

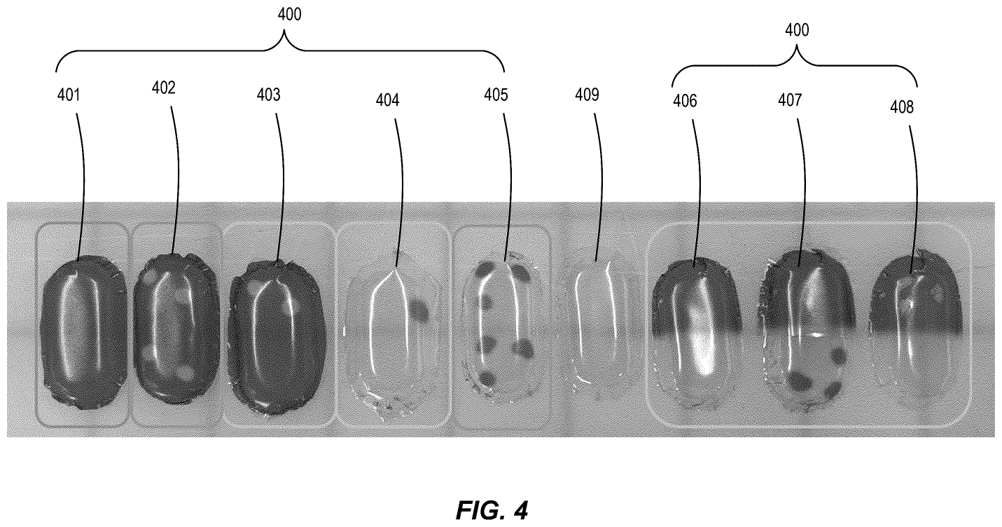

FIG. 4 illustrates examples of coloration domes 401-408 (collectively referred as coloration domes 400) and a clear dome 409. One or more of these domes 401-409 can be used as the domes 121 of the optic 120 (e.g., in FIGS. 1 and 2). In some embodiments, only coloration domes 400 are used such that the optic is devoid of clear domes 409. The coloration domes 400 can include a fully colored dome 401 and/or a partially colored dome (e.g., 402-408). The partially colored dome (e.g., 402-408) can include one or more colored portions and one or more clear portions. For example, the dome 402 and 403 can be a majority colored dome (e.g., more than 50%, 60%, 70%, 80% and/or 90% of the dome area being colored) distributed with one or more discrete clear portions (e.g., less than 50%, 40%, 30%, 20%, and/or 10% of the dome area being clear). The domes 404-405 can be a majority clear dome (e.g., more than 50%, 60%, 70%, 80% and/or 90% of the dome area being clear) distributed with one or more discrete colored portions (e.g., less than 50%, 40%, 30%, 20%, and/or 10% of the dome area being colored). In another example, a coloration dome (e.g., 406-408) can include a colored portion provided on only a first side of the partially colored dome and a clear portion provided on an opposing, second side of the partially colored dome. In yet another example, the partially colored domes (e.g., 402-405, 407, and 408) can include discrete clear portions and/or discrete colored portions that are asymmetrically distributed on at least some of the partially colored domes. In many embodiments, a total colored area of the colored optics or domes is less than a total colored projected area on the diffuser. For example, the total colored area may be less than 50%, less than 40%, or less than 30% than the total colored projected area on the diffuser.

As illustrated, the domes 121 can be provided in a plurality of rows (e.g., 121-1, 121-2) on the optic overlay 200. The same or different domes 121 may be provided within and between rows. The type (e.g., coloration domes 400 and clear domes 409) and placement of the domes on the overlay 200 may be strategically selected to help project the desired image on the diffuser. In some embodiments, a subset of the coloration domes (e.g., 401 and 402) may be positioned adjacent to other coloration domes (e.g., 403). In some embodiments, another subset of the coloration domes (e.g., 405 and 406) may be positioned adjacent a clear dome (e.g., 410). These positioning are only examples without limiting the scope of the present disclosure. The positioning of the coloration domes and the clear domes can be based on a particular image to be projected on the diffuser (e.g., 130). Alternatively or additionally, colored domes (e.g., blue, red, yellow, or other color) may be placed to create shapes and/or patterns associated with a predetermined image.

In some embodiments, the optic 120 can include apertures 122 between some adjacent dome rows. For example, a first aperture 122-1 is located between adjacent dome rows 121-1 and 121-2 in FIG. 2. When the optic 120 is positioned adjacent the light sources 110, (1) the domes (e.g., 121) seat over a first set of light sources 110, such that light from the first set of light sources 110 is emitted through the domes 121 and (2) the apertures 122 receive a second set of light sources 110, such that light from the second set of light sources 110 does not pass through domes 121.

In some embodiments, both the first and second sets of light sources are activated simultaneously so as to contribute to the generation of the predetermined image (e.g., sky). In other embodiments, only the first set of light sources (e.g., aligned with the domes 121) contributes to generation of the predetermined image. In such embodiments, the light sources 110 aligned with the apertures 122 may be activated or deactivated independently such that, when deactivated, they do not contribute to generation of the predetermined image (e.g., sky). This independence of activation of the first and second sets of light sources permits activation of only the second set of light sources (i.e., the light sources that effectively bypass the optic). In this way, the light fixture 100 may be controlled to emit only white light through a diffuser that is devoid of the image. Moreover, because the image is created only when the light sources 110 are activated, in a deactivated state the diffuser bears little to no evidence of the image.

The domes 121 may be sized and shaped such that each seats over a single light source or multiple light sources. Moreover, the domes 121 need not have the same size and/or shape within an optic. In some embodiments, the domes 121 can have an elongated, a semi-spherical, or other three-dimensional (3D) shape. An elongated dome can have a length that seats over a plurality of adjacent light sources 110. In some embodiments, the elongated shape can provide a way to implement dynamically changing image (e.g., of a sky). In some embodiments, the elongated shape provides more colored surface area or improved color blending. As an example, two side-by-side light sources can be on different channels (e.g., a second channel and a third channel). The elongated shape allows the two light sources to be placed under the same dome. The two light sources may be different colors or correlated color temperatures and can be controlled independently to create a dynamic version of the image. For example, intensity and/or color of the two light sources can be controlled to create variations of a sky appearance that can be used to simulate time-of-day sky effects or provide a natural and intuitive diming behavior that presents a cool noon sky at high intensity and moves to a warmer morning or evening sky appearance when the fixture is dimmed to low intensity. For example, a dimmer controller (e.g., intensity slider or rotatable button) can be used to control both intensity and color simultaneously. Accordingly, the variations can have a continuous range of colors for the same predetermined image.

Moreover, while the apertures 122 are illustrated as elongated slots that each receives a plurality of light sources 110, other embodiments may have a 1:1 correspondence between the apertures 122 and the light sources 110.

As shown in FIG. 1B, the optic 120 can be positioned proximate to at least some of the plurality of light sources 110. For example, the optic 120 is positioned closer to and/or coplanar with the plurality of light sources 110 and spaced by a distance d1 from the diffuser 130. When at least one light source of the light sources 110 is activated, light is emitted into and through the optic 120. The optic 120 further projects the predetermined image (e.g., a sky) on the diffuser 130. More specifically, light emitted by the optic 120 forms the image when it impinges upon the diffuser. In some embodiments, the distance d1 is maintained such that minimal to no pixelation of the predetermined image (e.g., the sky) can be seen from the diffuser 130. This gives a more realistic appearance of a scene e.g., the sky formed by lighting the predetermined image. If the distance d1 is too small, pixelations of the predetermined image can occur. If the distance d1 is too large, delineation between the white cloud and blue sky portions becomes more difficult. For example, the distance d1 between the optic 120 and the diffuser can be maintained less than 3 inches, between 1 inch to 3 inches, between 1.5 inches to 3 inches. In some embodiments, an optimal distance d1 may depend on the diffusion level of the diffuser, a pitch of the LED array (e.g., distance between immediately adjacent or consecutive LEDs), and whether or not backlight lenses are employed.

The present disclosure is not limited to a particular structure of the optics 120. In some embodiments, the optics 120 can include one or more optics. For example, the one or more optics can be a plurality of optics (e.g., domes). In some embodiments, the one or more optics can be a single colored piece (e.g., blue) with or without clear portions. For example, the single colored piece can be shaped and sized to cover multiple light sources to create a colored graphic portion of a predetermined image. This way, the single colored piece optic can create e.g., a blue sky portion of a sky.

FIG. 3 is an example optical subassembly 300 with light sources 310 and dome shaped optics 320. The optical subassembly 300 can be an example of the subassembly 105 (in FIG. 1). The light sources 310 can include a first set of light sources 310A and the second set of light sources 310B. The first set of light sources 310A are laterally spaced from the second set of light sources 310B. In the illustrated embodiment, arrow 310A indicates a row of first set of light sources 310A, and another arrow 310B indicates a row of the second set of light sources 310B. Although, only one row of 310A and 310B are pointed out for illustration purposes, the light sources 310A and 310B can be placed in several alternative rows, In one example, the light sources 310A and 310B can have identical light characteristics. In another example, the first set of light sources 310A can have first light characteristics and the second set of light sources 310B can have second light characteristics different from the first light characteristics. In some but not all embodiments, the first set of light sources 310A and the second set of light sources 310B can have one or more light parameters different from each other. For example, the light sources 310A can include cool white LEDs, and the second light sources 310B can include warm light LEDs. In some embodiments, the second light sources 310B can include a pair of or more than two sets of light sources (e.g., 310x, 310y, note only two are labelled for simplicity of illustration purposes and does not limit the scope of the present disclosure) having different light parameters. For example, the light sources 310x and 310y can have different characteristics or light parameters that can be controlled independently. The pair of light sources 310x and 310y can be placed underneath the optic 320 to create a dynamic sky image.

In the illustrated embodiment, the light sources 310 can be laid in rows and divided into a first channel 311 corresponding to the first set of light sources 310A and a second channel 312 corresponding to the second set of light sources 310B. The first set of light sources 310A (e.g., in the odd numbered rows) can be electrically coupled together to form the first channel 311. Similarly, the second set of light sources 310B (e.g., in the even numbered rows) can be electrically coupled together to form the first channel 312. In some embodiments, light sources of the first, the second, and/or additional channels can be controlled such that the images projected onto the diffuser may change. In some embodiments it is possible to change the appearance of the same image projected onto the diffuser. For example, the change of projected image can involve a color change (e.g., via CCT) to create a sky image having a warm morning sky, a cool day sky, or an evening sky appearance. In some embodiments, it is possible to create a totally different image or an object (e.g., a bird) within the image.

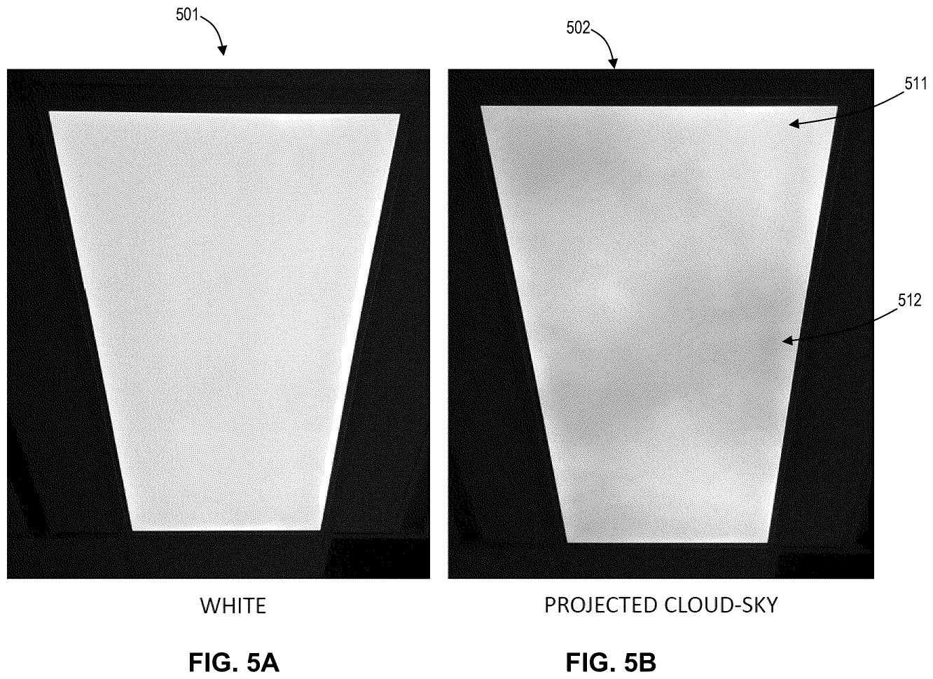

In some embodiments, the optic 320 can be an example of the optic 120 (see FIGS. 1-2). Accordingly, the optic 320 can include apertures and dome structures (e.g., similar to 121 and 122 in FIG. 2). For example, as shown in FIG. 3, domes 322 can be fully colored domes, a dome 324 can be a partially colored dome, and a dome 325 can be a clear dome. In the illustrated embodiment, only a few domes in one row are marked to explain the concept. Similar or different arrangements of domes are possible in other rows. The domes (e.g., 322, 324, 325) can be arranged within the rows and across different rows such that a predetermined image (e.g., a sky with white clouds and blue portions) can be created. For example, a subset of domes (e.g., 322, 324, 325) can be arranged within the plurality of optics 320 to emulate a sky appearance, such a sky appearance 502 shown in FIG. 5B. The colored portions of the subset of colored optics (e.g., 322, 324, 325) can generate a blue portion 512 (in FIG. 5B) of the sky appearance 502, and clear portions of the subset of colored optics and a subset of clear optics (e.g., 325) can generate a cloud portion 511 of the sky appearance 502.

In the illustrated embodiment, the first set of light sources 310A can be aligned with the apertures (e.g., 122 in FIG. 2) of the optic overlay (e.g., 120 in FIG. 2). The second set of light sources 310B can be aligned with the coloration domes (e.g., 121 in FIG. 2). The first set of light sources 310A and the second set of light sources 310B can be adapted to be independently controlled to create different lighting modes.

Referring to FIGS. 5A and 5B, a light fixture employing the optical subassembly 300 can be configured to operate in at least two modes—a non-image mode (e.g., see a first mode 501 in FIG. 5A) and an image mode (e.g., see a second mode generating the sky appearance 502 in FIG. 5B). The non-image mode (e.g., 501) can be active when the first set of light sources 310A is active and the second set of light sources 310B is inactive. Accordingly, as an example shown in FIG. 5A, in the non-image mode 501, only a white light is available to illuminate an area (e.g., an office, a hospital room, or a lobby). In the non-image mode 501, the predetermined image (e.g., the sky appearance 502) is not projected on the diffuser (e.g., 130). The image mode can be active when the first set of light sources 310A is inactive and the second set of light sources 310B is active. In the image mode, the predetermined image is projected on the diffuser (e.g., 130). Accordingly, as an example shown in FIG. 5B, in the image mode 502, a sky appearance is created. The shape and size of the respective white cloud and blue sky portions can be a function of the number and location of the colored domes and/or the amount of coloration of the colored domes.

FIG. 6 illustrates an example optical subassembly 600 including light sources 610 and discrete domes 620, according to some embodiments. In the illustrated embodiment, only colored domes are used, but one of ordinary skill in the art will understand that clear domes could be provided in addition to the colored domes. The discrete colored domes 620 may be located over selected light sources 610 based on a predetermined image to be generated. For example, the domes 620 can be located over light sources 610 to create a particular shape of blue portions of a sky appearance. In the illustrated embodiment, one dome 620 may be placed over one light source 610. Alternatively or additionally, one dome 620 may extend over two or more light sources. Alternatively or additionally, domes 620 may be placed to create shapes and/or patterns associated with a predetermined image. The optical subassembly 600 only has LEDs with identical light characteristics with discretely placed domes. Hence, when light sources 610 are activated, the optical subassembly 600 can operate only in an image mode (e.g., sky appearance), but not in white light only mode.

FIG. 7 illustrates the optical subassembly 600 with the light sources 610 activated. When the light from light sources 610 passes through the domes 620, a blue sky portion is projected on a diffuser (e.g., 130) and the light that does not pass through the domes 630 forms clouds. This way, a blue sky with clouds can be projected on the diffuser.

FIG. 8 illustrates an example sky appearance generated by the subassembly 600. In the illustrated image, blue portions 811 are created by light passing through the colored domes 620, while the white clouds 812 are created by remaining light that does not pass through the colored domes 620. The present disclosure is not limited to the illustrated sky appearance. In some embodiments, positions of the discrete domes 620 can be modified to create a different sky appearance, or include other patterns or colors. In some embodiments, the light sources 610 may include additional light sources to create a dynamic sky by tuning the light sources thereby creating a cool sky or a warm sky, for example. The ability to create a range of sky appearances from a cool sky and a warm sky can be used to simulate time-of-day sky effects or provide a natural and intuitive diming behavior that presents a cool noon sky at high intensity and moves to a warmer morning or evening sky appearance when the fixture is dimmed to low intensity.

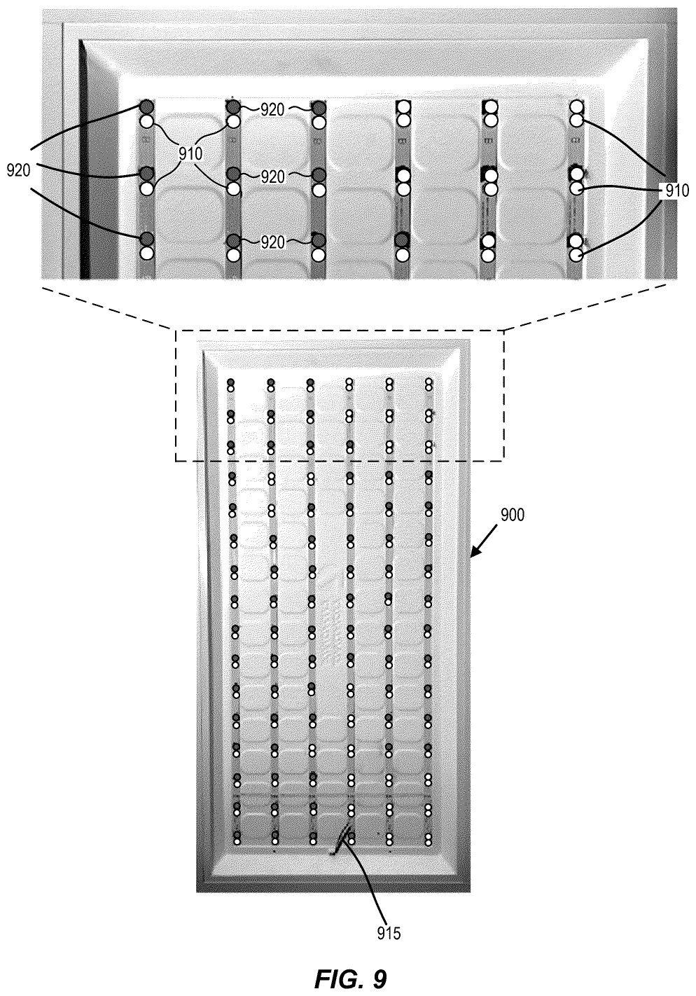

FIG. 9 illustrates an example image projection optical subassembly 900 including a first optics (e.g., backlighting lenses or “button optics”), according to one embodiment. In this embodiment, the first optics can be or include some clear optics 910 and some colored optics 920. Each of the first optics 910, 920 can be coupled over an LED. In some embodiments, the colored optic 920 can include colored portions. For example, one or more of the first optics can include fully or partially colored lens serving as the colored optic 920. In some embodiments, the image projection optical subassembly 900 can include two channels, a first channel and a second channel. The first channel can be formed by electrically connecting (e.g., by wires 915) together non-colored or the clear optics 910. The second channel can be formed by electrically connecting (e.g., similar to wires 915) together the colored optics 920.

The image projection optical subassembly 900 can be operated in two modes—a non-image mode and an image mode. The non-image mode can be activated by activating the first channel comprising the non-colored optics 910. This way, the image projection optical subassembly 900 can be operated in a white light only mode, for example.

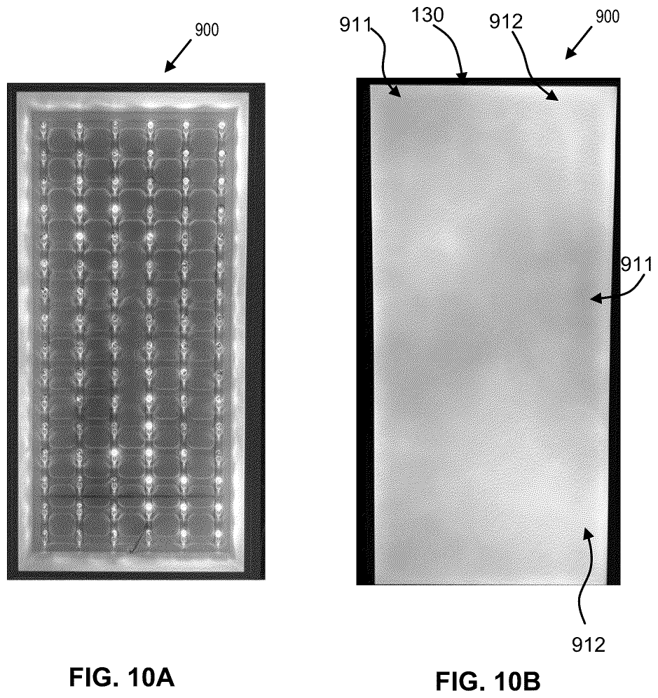

Referring to FIGS. 10A and 10B, the image mode of the image projection optical subassembly 900 can be activated by activating the second channel comprising the colored optics 920. This way, the image projection optical subassembly 900 can be operated to display a sky appearance 950 by projecting it on a diffuser (e.g., 130), as shown in FIG. 10B. Blue portions 911 of the sky appearance 950 can correspond to colored portions of the colored optic 920 and cloud portions 912 of the sky appearance 950 can correspond to clear portions of the colored optic 920 and the clear optics 910.

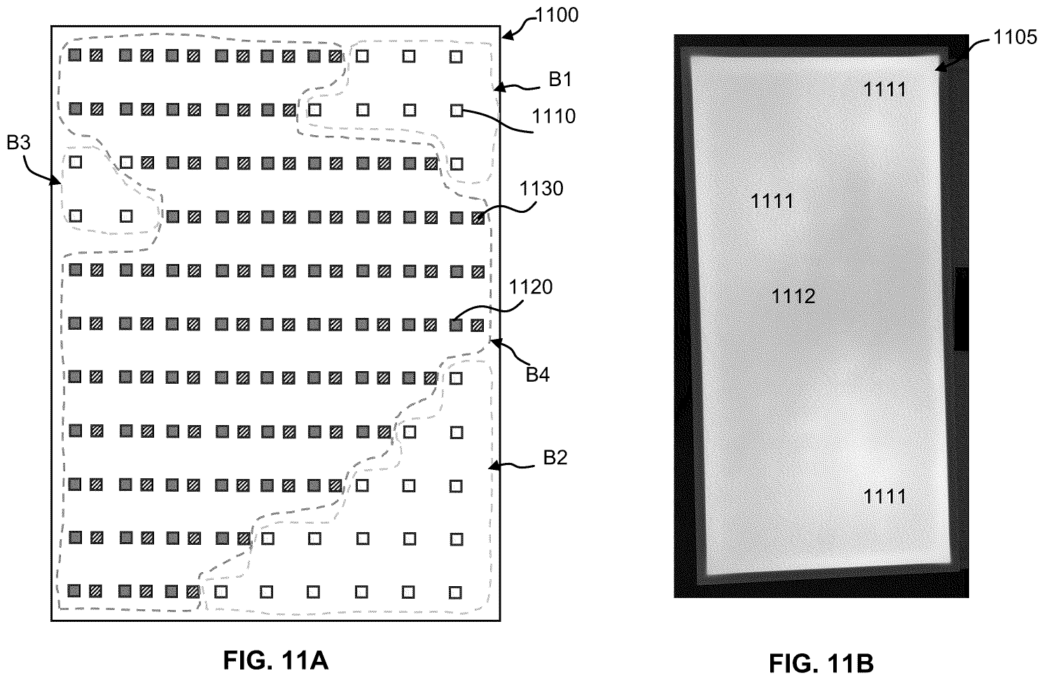

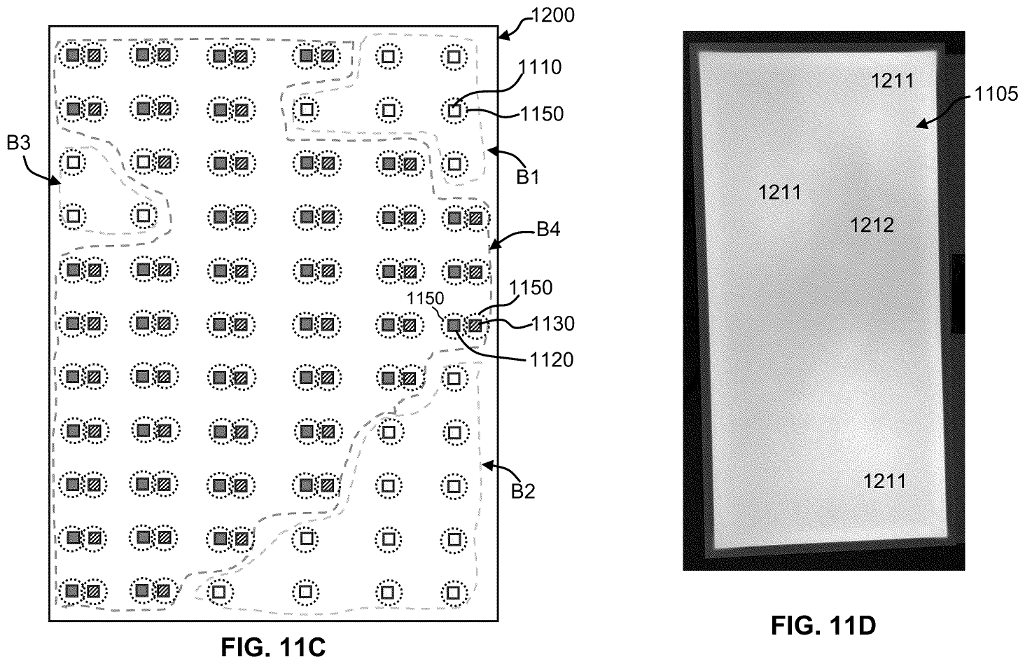

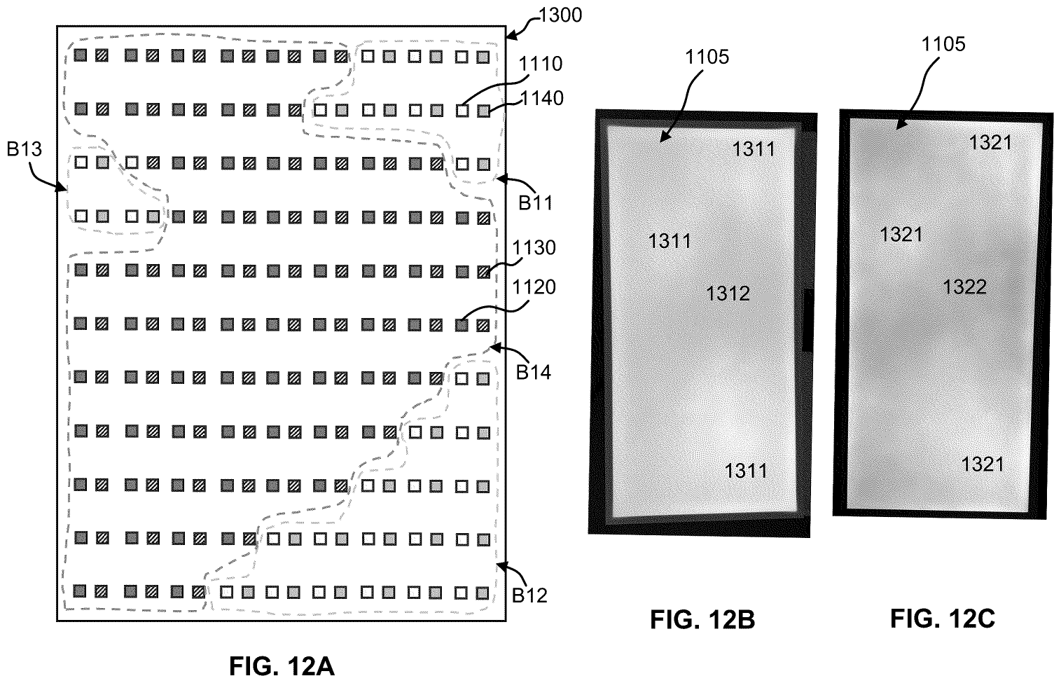

In some embodiments, a predetermined image can be generated without employing the colored optics. In these embodiments, light sources of different characteristics can be distributed relative to each other to form one or more patterns (e.g., clouds) of the predetermined image (e.g., sky). The light sources can be regularly spaced, but subsets of light sources can be distributed to form an irregular pattern. For example, an irregular pattern can be formed by staggered distribution of a group of light sources across different rows. In another example, an irregular pattern can be formed due to different distances between light sources of the subset of light sources. FIGS. 11A, 11C, and 12A illustrate example configurations of light sources configured to create different sky appearances such as shown in FIGS. 11B, 11D, 12B, and 12C. These light sources may or may not include a backlight lens. For example, FIGS. 11A, and 12A illustrate the light sources (e.g., LEDs) without a backlight lens over individual LEDs. FIG. 11C illustrates light sources individually covered with a clear backlight lens. The backlight lens may provide an improved light distribution that allows for increased LED spacing (and consequent reduced number of LEDs compared to the embodiments of FIGS. 11A and 12A) and/or color blending between patterns within the predetermined image when projected on a diffuser. The spacing between adjacent light sources in the embodiments disclosed herein can be uniform or non-uniform within an optical subassembly.

FIG. 11A illustrates an optical subassembly 1100 configured to generate a predetermine image without colored optics. FIG. 11B illustrates an example of the predetermined image projected on a diffuser by the optical subassembly 1100. The optical subassembly 1100 can include a first set of light sources 1110 (represented by clear squares within the array of light sources) and a second set of light sources 1120 (represented by solid filled squares within the array of light sources). In some embodiments, a third set of light sources 1130 (e.g., represented by patterned squares within the array of light sources) can be positioned adjacent to the second set of light sources 1120. Each set of light sources 1110, 1120, and 1130 can be on different channels and controlled independently. The first set of light sources 1110 and the third set of light sources 1130 can emit light of a first color (e.g., white). The second set of light sources 1120 can emit light of a second color different than that emitted by the first set of light sources 1110 (e.g., blue). For example, blue color can correspond to wavelengths in a range from 450 nm to 520 m or appropriate x,y values in CIE color space. The white color can correspond to CCT values in a range from 2700K to 6000K. The present disclosure is not limited to blue and white colors, and other colors are possible.

In the illustrated embodiment, the light sources 1110, 1120, 1130 may be regularly spaced from each other. However, the first light sources 1110 or the second light sources 1120 may be irregularly distributed within a layout of the light sources to create irregularly-shaped clouds or blue sky portions. For example, the first set of light sources 1110 may be irregularly distributed within the layout as represented by boundaries B1, B2, and B3. The second and third set of light sources 1120, 1130 may be irregularly distributed as represented within the boundary B4. The irregular distribution can refer to staggered distribution of a particular set of light sources among one row of light sources or between different rows of light sources. The present disclosure is not limited to the illustrated distribution of light sources 1110, 1120, 1130. As another example, the first light sources 1110 and the second light sources 1120 when grouped can form a regular pattern or layout such as a regular array (2×2, 2×3, 3×3, 3×4, etc.). Similarly, the first light sources 1110 and the third light sources 1130 can be grouped together to form a regular pattern.

In operation, the first and third set of light sources 1110, 1130 can be activated to activate a non-image or a white light only mode (e.g., similar to FIG. 5A). To activate an image mode (e.g., a sky image), the second set of light sources 1120 can be activated to create a blue sky portion, the first set of light sources 1110 can be activated to create a cloud portion, and the third set of light sources 1130 can be deactivated. An example of an image mode configured as a sky appearance is illustrated in FIG. 11B.

Referring to FIG. 11B, a diffuser 1105 can receive light from the light sources 1110, 1120, 1130. The diffuser 1105 can be spaced at a distance d1 (shown in FIG. 1B) from the light sources. Light emitted by the first light sources 1110 create clouds 1111 having irregular, whispy boundaries and the second light sources 1120 create the blue sky portions 1112. The clouds 1111 and blue portions 1112 can be projected on a light entry side of the diffuser 1105 to create a sky appearance visible from a light exit side of the diffuser 1105. The present disclosure is not limited to a particular arrangement of light sources and different positional variations are possible. Additionally or alternatively, a fourth set of light sources may be included to provide a dynamic changes to the predetermined image. For example, an image mode can be tuned by adjusting parameters of the second set of light sources in conjunction with parameters of the fourth set of light sources.

FIG. 11C illustrates an optical subassembly 1200, which can be substantially similar to the optical subassembly 1100 in that the light sources may be laid out in a similar manner as the optical subassembly 110. However, each light source is covered by a backlight lens. Similar elements of the optical subassembly 1100 and 1200 have same reference numerals. For example, a first set of light sources 1100 can be placed within the boundaries B1, B2, B3, and another set of light sources 1120 and 1130 can be placed within the boundary B4. Each of the light sources 1110, 1120, 1130 may be covered by a backlight lens 1150.

The backlight lens 1150 can control distribution (e.g., create a wide batwing distribution) of light from the corresponding light source(s). Accordingly, the light can be more uniformly distributed over the diffuser 130 from a reduced number of LEDs (and a correspondingly larger spacing between LEDs can be used), as shown in FIG. 11D. The sky image in FIG. 11D includes cloud portions 1211 and blue portions 1212, where the cloud portions 1211 may blend more uniformly with the blue portions 1212. Pattern of the portions 1211, 1212 can be substantially similar to portions 1111 and 1112 of the sky image in FIG. 11B.

FIG. 12A illustrates another example optical subassembly 1300 where the light sources are configured to create a color variation in a predetermined image (e.g., sky). For example, one variation can be a cool sky appearance (see FIG. 12B) and another variation can be a warm sky appearance (see FIG. 12C) or an intermediate mix thereof. The optical subassembly 1300 can include a first set of light sources 1110, a second set of light sources 1120, a third set of light sources 1130, and a fourth set of light sources 1140. Each of the light sources 1110, 1120, 1130, and 1140 can be on an individual channel. Accordingly, each light channel can be activated/deactivated or dimmed in relation to one another to create the predetermined image or variations of the predetermine image.

As shown in FIG. 12A, the light sources 1110, 1120, 1130 and 1140 are distributed in an irregular pattern within the same row and across different rows. The light sources 1110 and 1140 can be grouped together within boundaries B11, B12, and B13 to create different cloud portions. The light sources 1120 and 1130 can be grouped together within the boundary B14. In some embodiments, the first and fourth set of light sources 1110 and 1140 can be grouped to form a regular array (e.g., 2×2, 2×3, 3×4, etc.) within a boundary (e.g., B11). The illustrated layout of the light sources can create a sky image with clouds (e.g., corresponding to B11, B12, B13). The present disclosure is not limited to the illustrated grouping and positioning, and other grouping and positioning of the light sources is possible depending on a pattern to be created. Depending on the characteristics of each light sources 1110, 1120, 1130, and 1140 different variations of the sky image can be created.

The first and third light sources 1110 and 1130 can have the same or similar characteristics. For example, the light sources 1110 and 1130 can be white lights of the same intensity. These light sources 1110 and 1130 are distributed within different boundaries B11, B12, B13, and B14. When the first and third light sources 1110 and 1130 are activated, a non-image mode (e.g., a white light only mode) can be created.

The first, second, and fourth set light sources 1110, 1120, and 1140 can have different characteristics. For example, the first set of light sources 1110 can have a cool white color, the second set of light sources 1120 can have blue color, and the fourth set of light sources 1140 can have warm white color.

When the first set of light sources 1110 and the second set of light sources 1120 are activated, a sky with cool white clouds is created. For example, as shown in FIG. 12B, the first set of light sources 1110 create clouds 1311 corresponding to the boundaries B11, B12, B13 and the second set of light sources 1120 create a blue sky portion 1312 corresponding to the boundary B14.

When the fourth set of light sources 1140 and the second set of light sources 1120 are activated, a sky with warm white clouds is created. For example, as shown in FIG. 12C, the fourth set of light sources 1140 create clouds 1321 corresponding to the boundaries B11, B12, B13 and the second set of light sources 1120 create a blue sky portion 1322 corresponding to the boundary B14. Comparing FIGS. 12B and 12C, it shows that a sky image can be varied by activating or deactivating selected light sources and such sky image can be projected on the same diffuser 1105. Additionally, a sky image with clouds having an appearance anywhere in between warm white and cool white can also be achieved by varying the intensity ratio of light sources 1110 and 11040, for example.

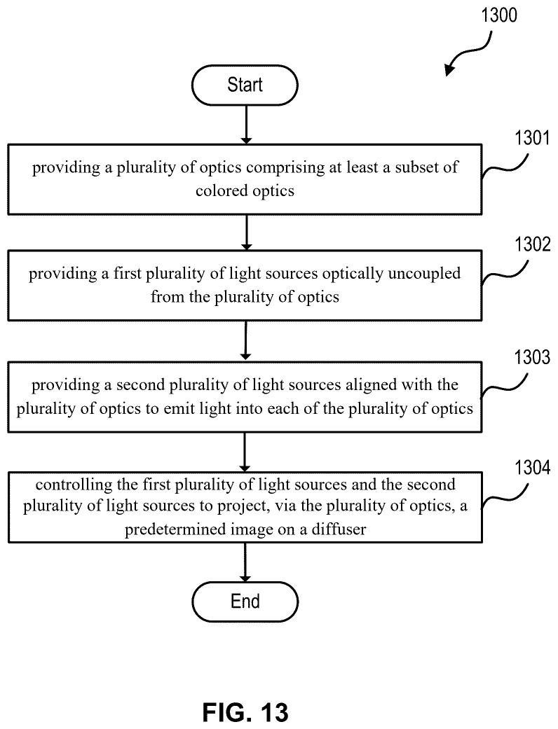

FIG. 13 is a flow chart of a method 1300 for lighting a diffuser, according to various embodiments. In many embodiments, the method employs one or more colored optics herein to project a predetermined image on the diffuser. The method can involve steps 1301-1304. Step 1301 involves providing a plurality of optics comprising at least a subset of colored optics. In some embodiments, the plurality of optics can include a plurality of domes 121 as shown in FIGS. 1 and 2. Examples of colored optics are illustrated in FIG. 4. In some embodiments, the plurality of optics can be discrete domes as shown in FIG. 6. As yet another example, the plurality of optics can be or included with backlight lens, as shown in FIG. 9.

Step 1302 involves providing a first plurality of light sources optically uncoupled from the plurality of optics. For example, the first plurality of light sources can be 310A coupled to form the first channel 311 as shown in FIG. 3. Step 1303 involves providing a second plurality of light sources aligned with the plurality of optics to emit light into each of the plurality of optics.

For example, the second plurality of light sources can be 310B coupled to form the second channel 312 as shown in FIG. 3. Step 1304 involves controlling the first plurality of light sources and the second plurality of light sources to project coloration onto a diffuser (e.g., 130 in FIG. 1) and thereby create an image on the diffuser. In many embodiments, the plurality of optics can be positioned more proximate to the second plurality of light sources than the diffuser.

In some embodiments, the method can further include steps involving deactivating the second plurality of light sources; and activating the first plurality of light sources to illuminate the diffuser only by light emitted by the first plurality of light sources. For example, as shown in FIG. 5A, a white light only may be projected through the diffuser (e.g., 130). Such white light only mode can be used for, e.g., medical examination or office use.

In some embodiments, the method can further include a step involving providing a third plurality of light sources. Further, light parameters of the second and/or the third plurality of light sources can be adjusted to project a varying image on the diffuser. Adjusting of the light parameters can involve controlling intensity of the second plurality of light sources in combination with the third plurality of light sources. In some embodiments, the light parameter can include at least one of: a CCT, intensity or light output, x-y point on CIE color space.

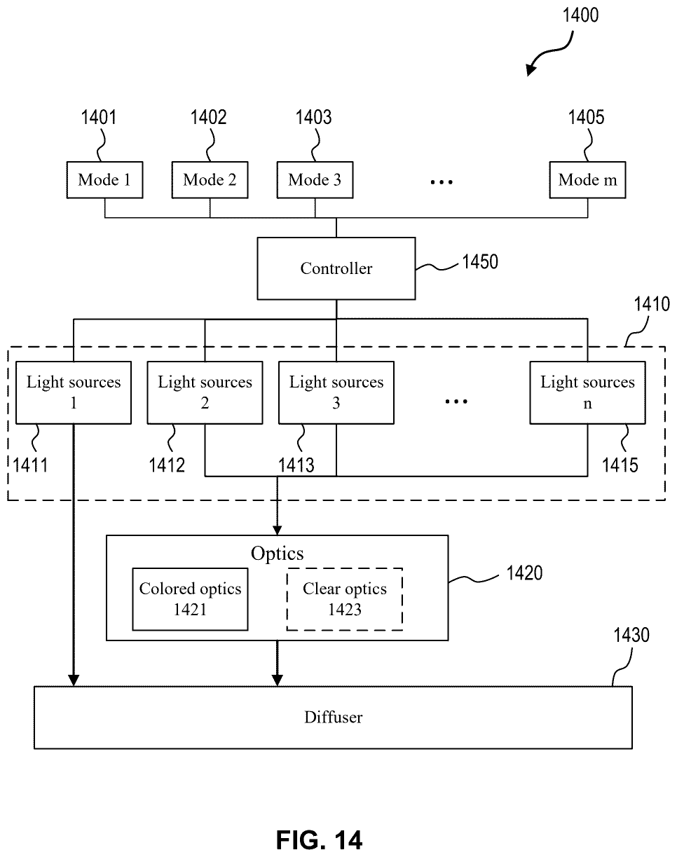

The embodiments herein are presented by way of examples to explain the concepts and other implementations are possible. FIG. 14 is a block diagram of a light fixture 1400 configured to generate a predetermined image, according to various embodiments of the present disclosure. The light assembly 1400 can be include a plurality of light sources 1410 and optics 1420 that can be configured such that the light assembly 1400 can be operated in one or more modes, e.g., a first mode 1401, a second mode 1402, a third mode 1403, . . . and/or an nth mode 1405. For example, a first mode 1401 can correspond to a white light only mode, the second mode 1402 can correspond to a cool sky appearance, the third mode 1403 can correspond to another scene or a variation of the sky appearance, etc. These modes can be created within the same aperture of the light fixture. By activating a desired mode (e.g., 1401, 1402, or 1403), the same light fixture advantageously can be used as an examination light, a sky emulation light and possibly time of day changes thereof, an office space light, etc.

The plurality of light sources 1410 can include a first set of light sources 1411, a second set of light sources 1412, a third set of light sources 1413, . . . and/or an nth set of light sources 1415. Each of the set of light sources 1411, 1412, 1413, 1415 can be associated with specified light parameter values, e.g., values of color, CCT, x-y values in CIE color space, or other parameter. Each of the light sources 1411-1415 can correspond to a particular channel so that one or more of the parameters associated with a particular set of light sources (e.g., 1411-1415) can be controlled by a controller 1450. The light sources 1410 can be arranged relative to each other to effectively generate the predetermined image, or a dynamic version of the predetermined image. For example, each of the set of light sources 1411-1415 can be arranged in separate row. In another example, one set light sources (e.g., 1412, or 1413) may be distributed in a uniform pattern (e.g., light sources grouped as 2×2, 2×3, 2×4, etc. in consecutive rows). In another example, one set light sources (e.g., 1412, or 1413) may be distributed in a non-uniform pattern (e.g., light sources distributed in non-consecutive rows such as 2 in one row, 4 in another row, 5 in yet another row, and so on). In some embodiments, the light sources 1410 may be arranged in a rectangular shape or other polynomial shape, or a circular shape.

In order to create different modes 1401-1405, one or more the light sources 1411-1415 may be selectively coupled to one or more colored optics 1421 and/or one or more clear optics 1423 based on the predetermined image to be generated. In some embodiments, the first light source 1411 may not be optically coupled to the optics 1420. Hence, light from the first light sources 1411 can be directly incident on one side of a diffuser 1430. This way, a non-image mode (e.g., a white light only mode) can be created. In some embodiments, one light source of the set of light sources (e.g., 1412) can be optically coupled to one colored optic 1421, or a clear optic 1423. Optically coupled indicates light from the light source is received within the colored optic 1421 or the clear optic 1423. In some embodiments, two (or more) light sources can be optically coupled to one colored optic 1421, or a clear optic 1423. For example, one light source of the light sources 1412 and one light source of the light sources 1413. This way, light parameters of the light sources (e.g., 1412, 1413) associated with one colored optic can be adjusted to create a variable or dynamic mode of a predetermined image can be created.

In the present disclosure, different types of “light sources” such as LED or other PCB mounted light sources, CFL light sources, fluorescent light sources, incandescent light sources, or the like can be used without limiting the scope of the present disclosure. For example, the “light sources” can be an LED light engine, which can be an integrated assembly composed of one or more light emitting diodes (LEDs) or LED arrays (modules), as well as an LED driver and other optical, thermal, mechanical and electrical components. The light sources can be configured to have a custom form factor. For example, the custom form factor can include variable dimensions (e.g., a variable width dimension, variable height dimension and variable depth dimension), shapes (e.g., rectangular, square, circular), or other available form factors of a lighting fixture.

A collection of exemplary embodiments, including at least some explicitly enumerated as “Examples” providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

Example 1. A light fixture comprising: a plurality of light sources; a diffuser spaced a distance from the light sources; and one or more optics positioned proximate and over at least some of the plurality of light sources such that at least one light source emits light into each of the one or more optics, wherein the one or more optics comprises at least a subset of colored optics, wherein the plurality of light sources project, via the one or more optics, a predetermined image on the diffuser.

Example 2. The light fixture of any of the preceding or subsequent examples or combination of examples, wherein the subset of colored optics are part of a first optic, wherein the first optic is configured to generate a wide batwing distribution.

Example 3. The light fixture of any of the preceding or subsequent examples or combination of examples, wherein other of the one or more optics comprise a subset of clear optics.

Example 4. The light fixture of any of the preceding or subsequent examples or combination of examples, wherein the subset of colored optics comprises coloration domes.

Example 5. The light fixture of any of the preceding or subsequent examples or combination of examples, wherein the coloration domes comprise at least one of: a fully colored dome and a partially colored dome having one or more colored portions and one or more clear portions.

Example 6. The light fixture of any of the preceding or subsequent examples or combination of examples, wherein the partially colored dome comprises at least one of: a colored portion provided on only a first side of the partially colored dome and a clear portion provided on an opposing, second side of the partially colored dome; a majority colored dome distributed with one or more discrete clear portions; and a majority clear dome distributed with one or more discrete colored portions.

Example 7. The light fixture of any of the preceding or subsequent examples or combination of examples, wherein the discrete clear portions and/or the discrete colored portions are asymmetrically distributed on at least some of the partially colored domes.

Example 8. The light fixture of any of the preceding or subsequent examples or combination of examples, wherein each of the coloration domes are elongated in shape to cover at least two light sources.

Example 9. The light fixture of any of the preceding or subsequent examples or

combination of examples, wherein the coloration domes are formed integrally with an optic overlay.

Example 10. The light fixture of any of the preceding or subsequent examples or combination of examples, wherein the optic overlay further comprises clear domes formed integrally with the optic overlay.

Example 11. The light fixture of any of the preceding or subsequent examples or combination of examples, wherein the coloration domes are provided in a plurality of rows on the optic overlay.

Example 12. The light fixture of any of the preceding or subsequent examples or combination of examples, wherein a subset of the coloration domes are positioned adjacent only other coloration domes, and/or another subset of the coloration domes are positioned adjacent a clear dome.

Example 13. The light fixture of any of the preceding or subsequent examples or combination of examples, wherein the optic overlay comprises a cutout between two rows of the plurality of rows.

Example 14. The light fixture of any of the preceding or subsequent examples or combination of examples, wherein the plurality of light sources comprises: a first set of light sources aligned with the cutouts on the optic overlay; and a second set of light sources aligned with the coloration domes, wherein the first set of light sources and the second set of light sources are adapted to be independently controlled.

Example 15. The light fixture of any of the preceding or subsequent examples or combination of examples, wherein the light fixture is configured to operate in at least two modes comprising: a non-image mode when the first set of light sources is active and the second set of light sources is inactive, wherein the predetermined image is not projected on the diffuser in the non-image mode; and an image mode when the first set of light sources is inactive and the second set of light sources is active, wherein the predetermined image is projected on the diffuser in the image mode.

Example 16. The light fixture of any of the preceding or subsequent examples or combination of examples, wherein the subset of colored optics are arranged within the one or more optics to emulate a sky appearance via projection, wherein the sky appearance is projected on the diffuser only when the plurality of light sources are activated.

Example 17. The light fixture of any of the preceding or subsequent examples or combination of examples, wherein colored portions of the subset of colored optics generate a blue portion of the sky appearance.

Example 18. The light fixture of any of the preceding or subsequent examples or combination of examples, wherein the subset of colored optics includes at one colored optic with clear portion configured to generate a cloud portion of the sky appearance, and/or the light fixture further includes a subset of clear optics configured to generate a cloud portion of the sky appearance.

Example 19. The light fixture of any of the preceding or subsequent examples or combination of examples, wherein each of the one or more optics is made of a non-diffusing material.

Example 20. The light fixture of any of the preceding or subsequent examples or combination of examples, wherein a total colored area of the colored optics is less than a total colored projected area on the diffuser.

Example 21. The light fixture of any of the preceding or subsequent examples or combination of examples, further comprises: an optic overlay comprising cutouts and the one or more optics positioned adjacent to the cutouts; a first set of light sources of the plurality of light sources aligned with the cutouts on the optic overlay; and a second set of light sources of the plurality of light sources aligned with the subset of colored optics, wherein the first set of light sources and the second set of light sources are adapted to be independently controlled.

Example 22. A lighting system for lighting an area, the lighting system comprising: a light fixture comprising a trim defining an aperture; a first plurality of light sources; and a second plurality of light sources; wherein the lighting system is configured to light the area in a first mode or a second mode through the aperture, wherein, in the first mode, the second plurality of light sources is inactive and the first plurality of light sources is active to light the area through the aperture, and wherein, in the second mode, the first plurality of light sources is inactive and the second plurality of light sources is active and projects a predetermined image through the aperture.

Example 23. The lighting system of any of the preceding or subsequent examples or combination of examples, wherein only white light is emitted from the lighting system in the first mode.

Example 24. The lighting system of any of the preceding or subsequent examples or combination of examples, further comprising a third plurality of light sources, wherein the second mode is tunable to project variations of the predetermined image.

Example 25. The lighting system of any of the preceding or subsequent examples or combination of examples, wherein a light intensity ratio of the second plurality of light sources and the third plurality of light sources is tunable to create the varying image.

Example 26. The lighting system of any of the preceding or subsequent examples or combination of examples, further comprising one or more optics comprising at least a subset of colored optics.

Example 27. The lighting system of any of the preceding or subsequent examples or combination of examples, wherein: the first plurality of light sources is laterally spaced from the one or more optics such that light emitted from the first plurality of light sources does not pass through the one or more optics, and the second plurality of light sources is aligned with the plurality of the optics to emit light into the one or more optics.

Example 28. The lighting system of any of the preceding or subsequent examples or combination of examples, further comprising: a diffuser spaced from the second plurality of light sources such that the one or more optics is interposed between the second plurality of light sources and the diffuser, wherein the one or more optics is disposed closer to the second plurality of light sources than the diffuser.

Example 29. The lighting system of any of the preceding or subsequent examples or combination of examples, wherein the subset of colored optics comprises coloration domes.

Example 30. The lighting system of any of the preceding or subsequent examples or combination of examples, wherein the coloration domes comprise at least one of: a fully colored dome and a partially colored dome having one or more colored portions and one or more clear portions.

Example 31. The lighting system of any of the preceding or subsequent examples or combination of examples, wherein the partially colored dome comprises at least one of: a colored portion provided on only a first side of the partially colored dome and a clear portion provided on an opposing, second side of the partially colored dome; a majority colored dome distributed with one or more discrete clear portions; and a majority clear dome distributed with one or more discrete colored portions.

Example 32. The light system of any of the preceding or subsequent examples or combination of examples, wherein the discrete clear portions and/or the discrete colored portions are asymmetrically distributed on at least some of the partially colored domes.

Example 33. The light system of any of the preceding or subsequent examples or combination of examples, further comprising: a lighting mode controller configured to control switch between the modes of the lighting system.

Example 34. The light system of any of the preceding or subsequent examples or combination of examples, wherein the lighting controller comprises at least one of: a switch or an electronic controller.

Example 35. A method for lighting a diffuser, the method comprising: providing one or more optics comprising at least a subset of colored optics; providing a first plurality of light sources optically uncoupled from the one or more optics; providing a second plurality of light sources aligned with the one or more optics to emit light into each of the one or more optics; and controlling the first plurality of light sources and the second plurality of light sources to project, via the one or more optics, a predetermined image on a diffuser, wherein the one or more optics is positioned more proximate to the second plurality of light sources than the diffuser.

Example 36. The method of any of the preceding or subsequent examples or combination of examples, further comprising deactivating the second plurality of light sources; and activating the first plurality of light sources to illuminate the area only by light emitted by the first plurality of light sources.

Example 37. The method of any of the preceding or subsequent examples or combination of examples, further comprising: providing a third plurality of light sources; and adjusting light parameters of the second and/or the third plurality of light sources so that the second and/or the third plurality of light sources together facilitate varying the image on the diffuser.

Example 38. The method of any of the preceding or subsequent examples or combination of examples, wherein the light parameter comprises at least one of: a CCT, intensity or light output, x-y point on CIE color space, wherein adjusting the light parameter comprises adjusting light intensity ratio of the second and/or the third plurality of light sources so that the second and/or the third plurality of light sources together facilitate varying the image on the diffuser.

Example 39. The method of any of the preceding or subsequent examples or combination of examples, wherein the colored optics comprise colored domes, each colored dome being configured to be positioned over one or more light sources of the second plurality of light sources.

Example 40. A light fixture comprising: a first set of LEDs spaced from each other, each LED of the first set of LEDs emitting light of a first color; a second set of LEDs spaced from each other to form an irregular layout within the light fixture, wherein within the irregular layout, the second set of LEDs are staggered between rows or spaced to have different distances among the second set of LEDs, each LED of the second set of LEDs emitting light of a second color different from the first color; and a diffuser spaced from the first and second set of LEDs, the diffuser comprising a light entry side and a light exit side, wherein light emitted by the first set of LEDs and the second set of LEDs is projected on the light entry side of the diffuser to create a predetermined image visible from the light exit side of the diffuser.

Example 41. The light fixture of any of the preceding or subsequent examples or combination of examples, wherein each of the first set of LEDs and/or the second set of LEDs are covered by a backlight lens.

Example 42. The light fixture of any of the preceding or subsequent examples or combination of examples, wherein the first color is white and the second color is blue so as to create a sky appearance comprising blue sky portions with white clouds.

Example 43. The light fixture of any of the preceding or subsequent examples or combination of examples, wherein the white is characterized by CCT values in a range from 2700K to 6000K, and the blue is characterized by wavelengths in a range from 450 nm to 520 m.

Example 44. The light fixture of any of the preceding or subsequent examples or combination of examples, further comprising: a third set of LEDs that are white in color and arranged adjacent to the second set of LEDs.

Example 45. The light fixture of any of the preceding or subsequent examples or combination of examples, wherein when both the first set of LEDs and the third set of LEDs are active, and the second set of LEDs are inactive, a uniform white light only mode is created on the diffuser.

Example 46. The light fixture of any of the preceding or subsequent examples or combination of examples, further comprising: a fourth set of LEDs arranged adjacent to the first set of LEDs, wherein when the fourth set of LEDs are activated and the first set of LEDs are deactivated a variation of the predetermined image is created, wherein the fourth set of LEDs have a different light parameter than the first set of LEDs.

Example 47. The light fixture of any of the preceding or subsequent examples or combination of examples, wherein a light intensity ratio of the fourth set of LEDs and the first set of LEDs are tunable to create variations of the predetermined image having a continuous range of colors.

Example 48. The light fixture of any of the preceding or subsequent examples or combination of examples, wherein the first set of LEDs are spaced from each other to form an irregular pattern within the light fixture.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics can be combined in any suitable manner in one or more embodiments. Further, it is intended that embodiments of the disclosed subject matter cover modifications and variations thereof.

It is to be understood that terms such as “top,” “bottom,” “front,” “side,” “length,” “lower,” “interior,” “inner,” “outer,” and the like that can be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Different arrangements of the components depicted in the drawings or described above, as well as components and steps not shown or described are possible. Similarly, some features and subcombinations are useful and may be employed without reference to other features and subcombinations.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their 10 equivalents are intended to cover such forms or modifications as would fall within the scope and spirit of the present disclosures.

What is claimed is:

1. A light fixture comprising:
a plurality of light sources;
a diffuser spaced a distance from the light sources; and
one or more optics positioned proximate and over at least some of the plurality of light sources such that at least one light source emits light into each of the one or more optics, wherein the one or more optics comprises at least a subset of colored optics,
wherein the plurality of light sources project, via the one or more optics, a predetermined image on the diffuser.

2. The light fixture of claim 1, wherein the subset of colored optics are part of a first optic, wherein the first optic is configured to generate a wide batwing distribution.

3. The light fixture of claim 1, wherein other of the one or more optics comprise a subset of clear optics.

4. The light fixture of claim 1, wherein the subset of colored optics comprise coloration domes.

5. The light fixture of claim 4, wherein the coloration domes comprise at least one of: a fully colored dome and a partially colored dome having one or more colored portions and one or more clear portions.

6. The light fixture of claim 5, wherein the partially colored dome comprises at least one of:
a colored portion provided on only a first side of the partially colored dome and a clear portion provided on an opposing, second side of the partially colored dome;
a majority colored dome distributed with one or more discrete clear portions; and
a majority clear dome distributed with one or more discrete colored portions.

7. The light fixture of claim 4, wherein each of the coloration domes are elongated in shape to cover at least two light sources.

8. The light fixture of claim 4, wherein the coloration domes are formed integrally with an optic overlay.

9. The light fixture of claim 8, wherein the coloration domes are provided in a plurality of rows on the optic overlay, and wherein the optic overlay comprises a cutout between two rows of the plurality of rows.

10. The light fixture of claim 9, wherein the plurality of light sources comprises:
a first set of light sources aligned with the cutout on the optic overlay;
a second set of light sources aligned with the coloration domes, wherein the first set of light sources and the second set of light sources are adapted to be independently controlled.

11. The light fixture of claim 10, wherein the light fixture is configured to operate in at least two modes comprising:
a non-image mode when the first set of light sources is active and the second set of light sources is inactive, wherein the predetermined image is not projected on the diffuser in the non-image mode; and
an image mode when the first set of light sources is inactive and the second set of light sources is active, wherein the predetermined image is projected on the diffuser in the image mode.

12. The light fixture of claim 1, wherein the subset of colored optics are arranged within the one or more optics to emulate a sky appearance via projection, wherein the sky appearance is projected on the diffuser only when the plurality of light sources are activated.

13. The light fixture of claim 12, wherein colored portions of the subset of colored optics generate a blue portion of the sky appearance.

14. The light fixture of claim 13, wherein the subset of colored optics includes at least one colored optic with clear portion configured to generate a cloud portion of the sky appearance, and/or the light fixture further includes a subset of clear optics configured to generate a cloud portion of the sky appearance.

15. The light fixture of claim 1, wherein each of the one or more optics is made of a non-diffusing material.

16. The light fixture of claim 1, wherein a total colored area of the colored optics is less than a total colored projected area on the diffuser.

17. A lighting system for lighting an area, the lighting system comprising:
a light fixture comprising:
a trim defining an aperture;
a first plurality of light sources; and
a second plurality of light sources;
wherein the lighting system is configured to light the area in a first mode or a second mode through the aperture,
wherein, in the first mode, the second plurality of light sources is inactive and the first plurality of light sources is active to light the area through the aperture, and
wherein, in the second mode, the first plurality of light sources is inactive and the second plurality of light sources is active and projects a predetermined image through the aperture.

18. The lighting system of claim 17, wherein only white light is emitted from the lighting system in the first mode.

19. The lighting system of claim 17, further comprising a third plurality of light sources, wherein the second mode is tunable to project variations of the predetermined image, wherein a light intensity ratio of the second plurality of light sources and the third plurality of light sources is tunable to create the varying image.

20. The lighting system of claim 17, further comprising one or more optics comprising at least a subset of colored optics.

21. The lighting system of claim 20, wherein:
the first plurality of light sources is laterally spaced from the subset of colored optics such that light emitted from the first plurality of light sources does not pass through the subset of colored optics, and
the second plurality of light sources is aligned with the plurality of the optics to emit light into the subset of colored optics.

22. The lighting system of claim 20, further comprising: a diffuser spaced from the second plurality of light sources such that the one or more optics is interposed between the second plurality of light sources and the diffuser, wherein the one or more optics is disposed closer to the second plurality of light sources than the diffuser.

23. The lighting system of claim 20, wherein the subset of colored optics comprises coloration domes.

24. The light system of claim 17, further comprising: a lighting mode controller configured to control switching between different modes of the lighting system.

25. A light fixture comprising:
a first set of LEDs spaced from each other, each LED of the first set of LEDs emitting light of a first color, the first set of LEDs being spaced from each other to form an irregular layout within the light fixture, wherein within the irregular layout, the first set of LEDs are staggered between rows or spaced to have different distances among the first set of LEDs;
a second set of LEDs spaced from each other to form another irregular layout within the light fixture, wherein within the irregular layout, the second set of LEDs are staggered between rows or spaced to have different distances among the second set of LEDs, each LED of the second set of LEDs emitting light of a second color different from the first color; and
a diffuser spaced from the first and second set of LEDs, the diffuser comprising a light entry side and a light exit side,
wherein light emitted by the first set of LEDs and the second set of LEDs is projected on the light entry side of the diffuser to create a predetermined image visible from the light exit side of the diffuser.

26. The light fixture of claim 25, wherein the first color is white and the second color is blue so as to create a sky appearance comprising blue sky portions with white clouds, and wherein the white color is characterized by CCT values in a range from 2700K to 6000K, and the blue color is characterized by wavelengths in a range from 450 nm to 520 m.

27. The light fixture of claim 25, further comprising: a third set of LEDs that are white in color and arranged adjacent to the second set of LEDs, and wherein when both the first set of LEDs and the third set of LEDs are active, and the second set of LEDs are inactive, a uniform white light only mode is created on the diffuser.

28. The light fixture of claim 27, further comprising: a fourth set of LEDs arranged adjacent to the first set of LEDs, wherein when the fourth set of LEDs are activated and the first set of LEDs are deactivated a variation of the predetermined image is created, wherein the fourth set of LEDs have a different light parameter than the first set of LEDs, and wherein a light intensity ratio of the fourth set of LEDs and the first set of LEDs are tunable to create variations of the predetermined image having a continuous range of colors.
